(19) United States
(12) Patent Application Publication
(10) Pub. No.: US 2004/0267917 A1
(43) Pub. Date: Dec. 30, 2004

(54) Wireless downloading of theme oriented content

(76) Inventors: Timo Tokkonen, Oulu (FI); Takaluoma Antti, Ii (FI)

Correspondence Address: HARRINGTON & SMITH, LLP, 4 RESEARCH DRIVE, SHELTON, CT, 06484-6212, US

(21) Appl. No.: 10/608,517

(22) Filed: Jun. 26, 2003

(51) Int. Cl. G06F 15/173

(52) U.S. Cl. 709/223

(57) ABSTRACT

Disclosed herein are methods and apparatus for providing context sensitive material to an individual. The context sensitive material relates to the context of a theme. The theme may involve a temporal event, such as a movie. The theme may involve an apparatus, such as an appliance, wherein the context of the appliance changes as a result of the manipulation of components of the appliance. The theme may involve elements within a set, wherein aggregation of the elements forms the theme. The context sensitive material may contain any information to provide the individual with further perspective on the theme. The context sensitive material is preferably stored in a database, and preferably may be retrieved over a network, such as the Internet.

### TECHNICAL FIELD OF THE INVENTION

This invention relates to downloading information related to a certain theme with a wireless device.

### BACKGROUND OF THE INVENTION

As wireless devices have become ever more prevalent in society, the ability to engage in communications has increased dramatically. Incorporation of certain processing capabilities with wireless devices has further enhanced the conventional wireless telephone, and provided users with abilities to receive and manipulate data with a wireless device. Examples of suitably equipped wireless devices include certain mobile telephones, as well as personal digital assistants (PDA) having mobile communications abilities.

It is known to download information to a wireless devices. At present, an enormous quantity of materials is available for PDA users to download. Examples include maps, schedules, and other similar data. However, present applications providing for the downloading of context sensitive material are limited. That is, while users may download a subway schedule, a user is typically uninformed as to whether the trains are running on time.

The provision and use of context sensitive material is also known. For example, advanced electronic programming guides for television broadcasts provide users with additional information. One example is produced by Wink Communications of Alameda California. Wink Communications provides a system that is purported to deliver interactivity synchronized to television programming and advertising. The system is intended to provide interactive enhancements which a user can choose to see while watching a TV show or advertisement.

What is needed is a system for wireless downloading of content that is related to a certain theme and maintained in context with the theme.

### SUMMARY OF THE INVENTION

The foregoing and other problems are overcome by methods and apparatus in accordance with embodiments of this invention.

Disclosed herein are techniques for downloading information as additional content about a certain theme. In the preferred embodiment, a movie goer is provided with multiple opportunities to download information about particular scenes within the movie. Information such as promotional materials, movie clips, interesting facts, the titles of currently playing music may be downloaded as guided by the interest of the movie goer.

Preferably, the user is alerted to the availability of additional content, and can download the additional content with relative ease, such as by one “touch” or “click” using the wireless device. In some embodiments, downloading of material is only possible for a limited period of time, such as during a relevant scene in a movie. The context sensitive material may be distributed through a variety of apparatus, such as are presently known and used for local communications.

The downloading of additional content is not limited to the preferred embodiment, and it is considered that the embodiments provided herein are illustrative only and not limiting of the invention.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a graphic depiction of aspects of a movie theater;

FIG. 2 is a graphic depiction of exemplary devices for receiving context sensitive material;

FIG. 3 is a graphic depiction wherein a series of communication ports provide context sensitive information;

FIG. 4 is an exemplary icon appearing in a movie broadcast in a theater;

FIG. 5 is an illustration of a second setting where the teachings herein may be practiced;

FIG. 6 is an illustration of aspects of a network included in the embodiment shown in FIG. 5;

FIG. 7 is an illustration of aspects of a third setting where the teachings herein may be practiced;

FIG. 8 depicts a kiosk for practicing the teachings disclosed herein;

FIG. 9 depicts a wireless device touching a port; and,

FIG. 10 depicts aspects of a wireless device suited for practice of this invention.

### DETAILED DESCRIPTION OF THE INVENTION

Disclosed herein are methods and apparatus for broadcasting and receiving supplementary information, wherein the supplementary information provides users with useful information regarding a theme of interest.

The methods and apparatus disclosed herein are largely discussed in terms of a preferred embodiment, where the “theme” is a movie. However, one skilled in the art will recognize that the teachings herein may be applied in a variety of settings, and therefore, the teachings herein are not limiting of the invention.

As used herein, a “theme” is any topic with which additional information is associated and provides a changing context. Examples include topics that have a temporal aspect, such as a movie, or an amusement ride at a theme park. Other examples include an apparatus with which a volume of information is associated. In this example, the changing context of an apparatus relates to the sequence of operation of the apparatus (i.e., steps in manipulation of the components of the apparatus). A theme may include various elements, wherein aggregation of the elements forms a set. Among other things, the invention herein provides for the distribution to users of context sensitive material related to the present context of a theme.

Therefore, as used herein, a network may be “synchronized with the sequence of the theme” wherein the timing of distribution of context sensitive material is correlated to a temporal aspect of the theme. A network may also be “synchronized with the operation of the theme” or “synchronized with the apparatus” wherein the distribution of context sensitive material is dependent upon the present manipulation of the components of an apparatus. A network may also be “synchronized with the elements of the theme” wherein the distribution of context sensitive material is dependent upon the present elements included in a theme. In summary of the foregoing, it is appropriate to consider that the network may be “synchronized with the theme” prior to the distribution of context sensitive material.

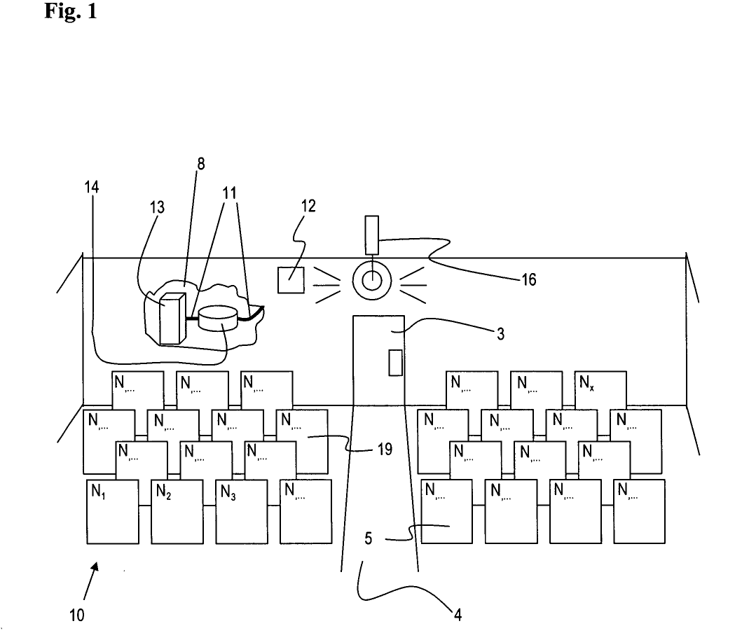

In FIG. 1, there is shown a setting where individuals are presented with a theme. In the exemplary embodiment shown, the setting is a movie theater 10. For point of reference only, individuals enter through door 3, progress down the aisle 4, and find a seat N₁ through Nₓ. Once seated, the individuals are presented with the showing of a movie (i.e., the theme). The movie is started by an operator in the projection booth 12 who operates equipment necessary to broadcast a pre-recorded film, video, or other media containing theme content. In FIG. 1, a cutaway portion 8 of the theater back wall is also shown. Through the cutaway portion 8, a processing unit 14, a database 13 and portions of a network 11 are shown.

In this embodiment, the network 11 is connected to the antenna 16 (also referred to herein in other embodiments, as a “port”). Upon request by a user, the antenna 16 provides a low power signal containing context sensitive material. The context sensitive information preferably originates from the database 13, and selected by the processing unit 14. The processing unit 14 generally selects the context sensitive material after being synchronized with the theme content.

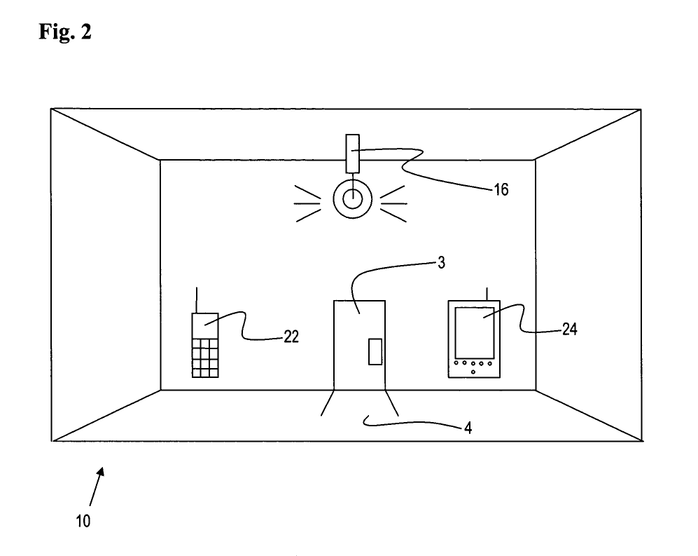

The signal is received by a user seated in the seat 5 to the right of the aisle 4, and another user seated in the seat 19 to the left of the aisle 4. As shown in FIG. 2, the individual to the left of the aisle 4 receives a signal from the antenna 16 using a mobile telephone 22. The individual to the right of the aisle 4 receives a signal using a PDA 24 which is equipped for wireless communications. Some of the other individuals attending the movie may receive signals with other appropriate devices. However, for illustration of the teachings herein, the disclosure generally discusses the devices only in the preferred embodiments where mobile telephones 22 and PDAs 24 are used. It is recognized that other non-limiting devices, such as laptops with wireless communications interfaces and pagers could be used. Therefore, the disclosure herein is not limiting of devices that may be used in accordance with the teachings herein.

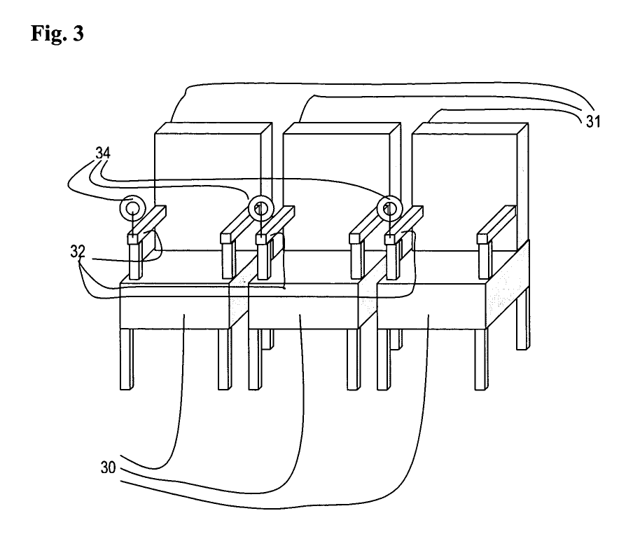

In a preferred embodiment, shown in FIG. 3, the context sensitive information is distributed exclusively through a series of communications ports 34, which are a part of the network 11. In this embodiment, broadcasting of the context sensitive material (also referred to as “supplementary information”) occurs in what is generally considered low power operation. Preferably, in this embodiment, a user need only “touch” the ports 34 to order or receive the supplementary information.

As used herein, “contact” or “touch” means that a user need only acknowledge a request to send the context sensitive information, or otherwise complete a handshake with the network 11, in order to begin a download of the context sensitive information. This can include use of a device which is limited to receiving signals only (e.g., a pager). Using such devices, is it possible to handshake by the affirmative act of placing the device next to or in contact (i.e., touching) the port 34. Preferably, the system can be implemented using low power radio frequency (rf) tags and each device 22, 24 should be within some short range from the ports 34, for example, a few inches, when receiving material. Various embodiments of communications may be used to enable a wireless device making contact with a network.

In this embodiment, the ports 34 are integrated into a fixture, such as a seat 30, for each user. For example, the ports 34 may be incorporated into the armrest 32 of the seat 30. In an alternative embodiment, the ports 34 are located in the middle of each seatback 31, and a user need only lean forward to “touch” the port 34. Other embodiments of distribution methods and apparatus may used, such as by short messaging service (SMS) with location support. An additional example of a technique for downloading includes use of the infrared (IR) communications port commonly available on PDAs 24. In general, the method of contacting the network is based upon many factors, including the physical constraints of the setting and the characteristics of the data to be downloaded. A further embodiment of a suitable communications protocol for contacting the network is the Bluetooth® standard developed by Bluetooth SIG, Inc. of Overland Park, Kans. USA.

The Bluetooth® wireless specification includes both link layer and application layer definitions for product developers which supports data, voice, and content-centric applications. Preferably, radios that comply with the wireless specification operate in the unlicensed 2.4 GHz radio spectrum. Typically, this specification calls for radios that use a spread spectrum, frequency hopping, full-duplex signal at up to 1600 hops/sec. The signal hops among 79 frequencies at 1 MHz intervals to give a high degree of interference immunity. Preferably, up to seven simultaneous connections can be established and maintained. As used herein, the Bluetooth® wireless specification is generically referred to as a communications protocol that uses “a spread spectrum, frequency hopping, full-duplex signal.” It is recognized that the Bluetooth® specification includes many other aspects, however, it is considered that other similar protocols may be described by these aspects.

Referring back to FIG. 1, various techniques may be used to synchronize the supplementary information with the theme. For example, the processing unit 14 may monitor electronic or visual queues in the media. In this embodiment, the processing unit 14 automatically synchronizes the film with the database 13 containing context sensitive material. In other embodiments, this task may be completed manually, such as where the media and the processing unit 14 are started simultaneously by the operator. In this embodiment, the processing unit 14 tracks the sequence of the theme using an internal clock (or another device), and generally operates independently of the media.

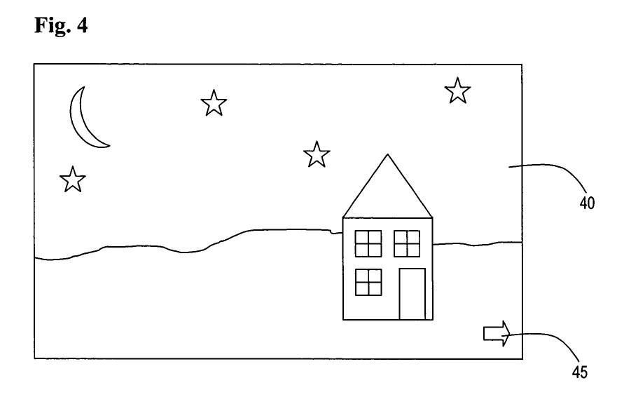

As shown in FIG. 4, a visible icon 45 may be included in the film 40 as it is broadcast to the general audience. Preferably, the icon 45 is presented to indicate the availability of supplementary information. In other embodiments, notification of the availability of the supplementary information is provided by a signal transmitted to the wireless device 22, 24. The wireless device 22, 24 may then enter automatic downloading, or actuate a user notification, such as an audible alarm wherein the user is prompted to accept or reject a download. In some embodiments, notifications to the user are produced by the processing unit 14.

The context sensitive material for downloading is always linked to the present theme. For example, the user is presented with content applicable to the movie showing in the theater 10 where the user is located. Additional filters may be applied to increase the relevance of the data for the user. For example, the content may be linked in time, such as to the sequence of the theme, so that a user may only download content for a particular scene while that scene is being shown. In this embodiment, an icon 45 may be present on screen for the duration that the additional content is available. As one non-limiting alternative, an icon 45 may be presented to introduce a segment when the additional content is coming available, and then disappear. Another icon 45 will appear to provide warning of the termination of the segment with adequate time so that a user may obtain the supplementary data while still available. Icons 45 may be included in the film, be produced by a digital overlay, added by a laser, or by any other technique that is appropriate. Icons may be color coded, geometrically coded or otherwise displayed or oriented so as to signify aspects of the context sensitive information available for downloading.

In another embodiment, the theater operator maintains a separate micro-network in the theater 10. In this embodiment, the theater operator introduces local content (i.e., content other than that produced with the film). Examples of local content include, without limitation, promotional material such as, electronic coupons, contests, giveaways, local advertising, similar promotional and other information. In a further embodiment, a port 34 is included in a poster relating to a certain movie. A user can contact a network included in the poster with the wireless device 22, 24 to download the context sensitive material. Context sensitive material may contain information such as, without limitation, promotional materials, movie clips, interesting facts, the titles of currently playing music may be downloaded as guided by the interest of the movie goer.

Other embodiments of downloading context sensitive material are contemplated by the teachings herein. Two further and non-limiting examples of embodiments are presented. In a first embodiment, a user downloads context sensitive material at a retail outlet, such as a grocery store. In a second embodiment, home appliances provide a theme for context sensitive material.

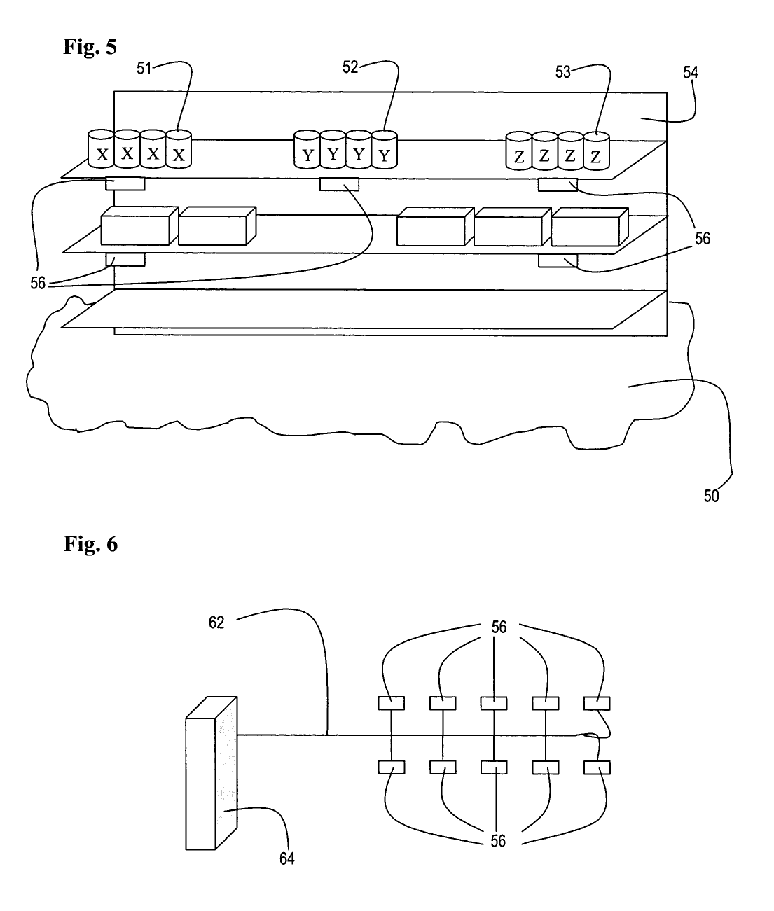

The first of the two additional exemplary embodiments is depicted in FIG. 5. In FIG. 5, a grocery store 50 is stocked with a variety of items 51, 52, 53. The items 51, 52, 53 are stored on shelving 54, or in other suitable apparatus, such as in a refrigerated display case (not shown). The shelving 54 includes a series of communications ports 56. Each one of the ports 56 provides content for the item 51, 52, 53 with which it is associated.

FIG. 6 shows each port 56 is connected in a network 62 to a central server 64. In this embodiment, the server 64 is programmed to provide information for broadcast through each of the ports 56. In the operation of the system depicted, a user may desire more information about a certain product 51, 52, 53. The user touches the user's device 22, 24 to the port 56 of choice. The server then provides the context sensitive information through the network connection. Examples of context sensitive information include, and are not limited to: recipes; nutritional information; promotional information; competitive product information; and, unit price information. Preferably, the ports 56 provide highly localized or directed signals so as to prevent crosstalk between other ports 56 in the network 62. One example of a suitable port structure includes an IR communications port 56 adapted for communications with an IR port on a PDA 24.

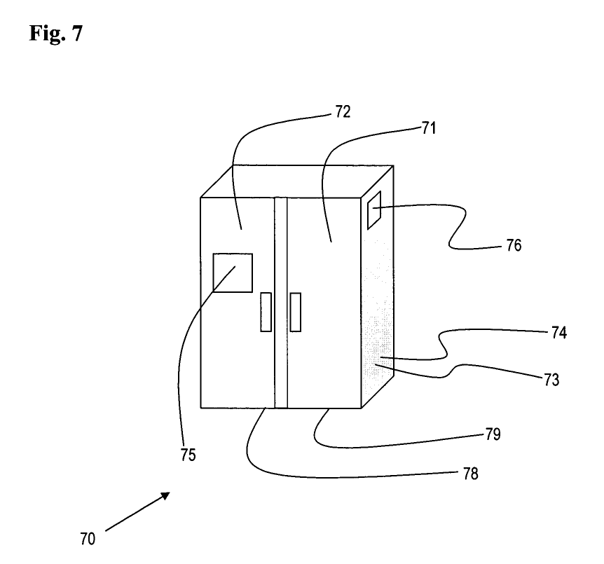

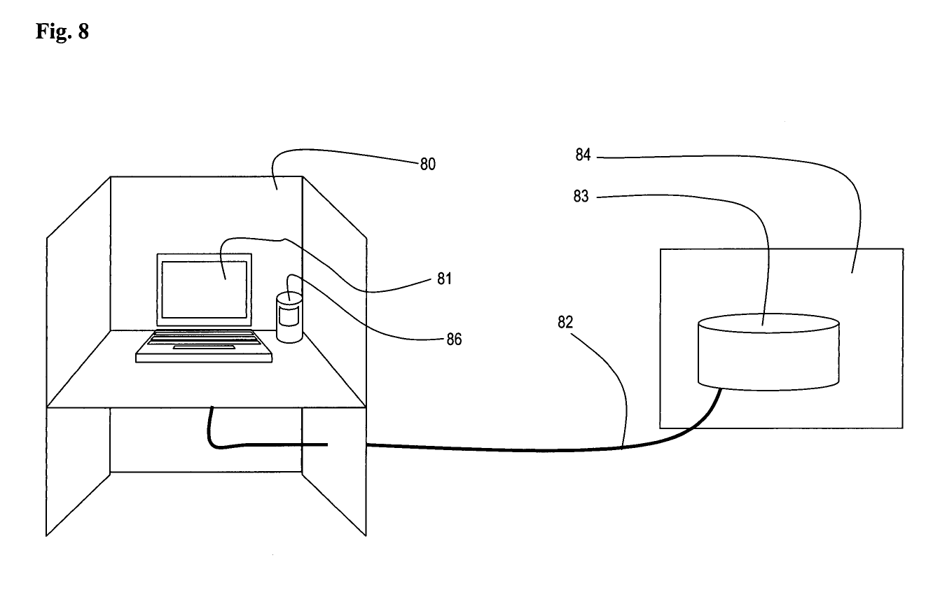

In another embodiment, shown in FIG. 7, an appliance 70, shown here as a refrigerator/freezer, is provided with a database 73 containing information for distribution as context sensitive material. In some embodiments, the database 73 is maintained by an internal processing unit 74. The database 73 may be added to, with the addition of performance related data. In some embodiments, the database 73 is updated with a periodic download via an interface, such as a floppy drive (not shown) or a network connection, such as to the Internet (shown in FIG. 8). The processing unit is connected to a port 76 which provides a user interface. In this embodiment, the user may access the internal processing unit 74 through the port 76, to conduct a query. The query may be actuated by other functions, such as the operation of the appliance 70. For example, if the user presses an appropriate button (not shown) or turns on the ice maker 75, the internal processing unit 74 provides instructions through the port 76 regarding operation of the icemaker 75.

Further embodiments of the invention include providing troubleshooting information. For example, it is known that many appliances 70 contain “smart” electronics, which include various sensors. Exemplary sensors in the embodiment shown in FIG. 7 include a freezer temperature sensor 72 and a refrigerator temperature sensor 71, a sensor for monitoring the compressor output 78, and a sensor for monitoring the coolant level 79. In this example, the internal processing unit 74 continuously monitors the temperature sensors 71, 72. If the temperature in either the freezer or the refrigerator exceeds an assigned tolerance corresponding to the user setting, the processing unit 74 conducts a diagnostic test. One example of a diagnostic test includes evaluating the compressor output sensor data and the coolant level data against desired specifications. The user may then be provided with an alarm, or otherwise notice that the temperature is not within the desired range. Accordingly, the user seeks information from the processing unit 74 via the port 76. The processing unit 76 provides the context sensitive material to the user. For example, the user may be notified that the coolant level is appropriate, but that the compressor output is low, and that a cleaning of a heat exchanger is indicated. The processing unit 74 provides the user with instructions on how to clean the heat exchanger or contact information for local service centers.

It is considered that the foregoing exemplary embodiment provided in regard to FIG. 7 is rudimentary, and not exhaustive of the potential for the teachings herein. Consider that other more sophisticated appliances, such as an automobile, involve considerably more information and require more sophisticated troubleshooting.

Further examples of embodiments incorporating aspects of the teachings herein include presenting users with a kiosk or other outlet, as shown in FIG. 8. In FIG. 8, a kiosk 80 is made available to a user. The kiosk 80 may be at a retail center, such as an automobile dealer or a home center. In one embodiment, the user is presented with a display 81 of pre-recorded information, such as a review of new models, or an introduction to a technique for using a tool. The user is provided with additional context sensitive material through an interface 86. For example, in the case of the automobile dealer, the user may be provided information, such as, without limitation, specifications on new models, performance data, specifications, technical updates, operator's manuals, promotional material, or similar material. In the case of a home center, a user may be provided with information such as, without limitation, an operator's manual for a new tool, further instruction on a specific topic, additional projects, pricing information, promotional items, competitive products, and others.

Preferably, the kiosk 80 is connected to a network 82, such as the Internet. Using the network 82, the operator of the kiosk 80 is able to ensure that a user receives comprehensive context sensitive information. That is, a central database 83 is maintained and continuously updated by a distributor 84. In preferred embodiments, the distributor 84 tracks requests for information, and ensures that the context sensitive material addresses frequent requests of users.

In some embodiments, the kiosk 80 is configured for individual use. For example, a user may run pre-recorded promotional material at an automobile dealership. In other embodiments, the kiosk 80 supports multiple users. For example, the kiosk 80 may be set up as a side display during an ongoing live demonstration, such as a workshop at a home center. Aspects of the first embodiment, wherein context sensitive material is provided in a theater 10, may also be advantageously used in this embodiment.

A further embodiment provides for downloading of schedule information. For example, a user may enter a kiosk 80, and touch the port 86 to make contact with the network 11. The kiosk 80 is oriented in a certain location, such that aspects of the theme are at least partially established by the placement of the kiosk 80. In this embodiment, the user is provided with context sensitive material by stopping by the kiosk 80 long enough to touch the port 86.

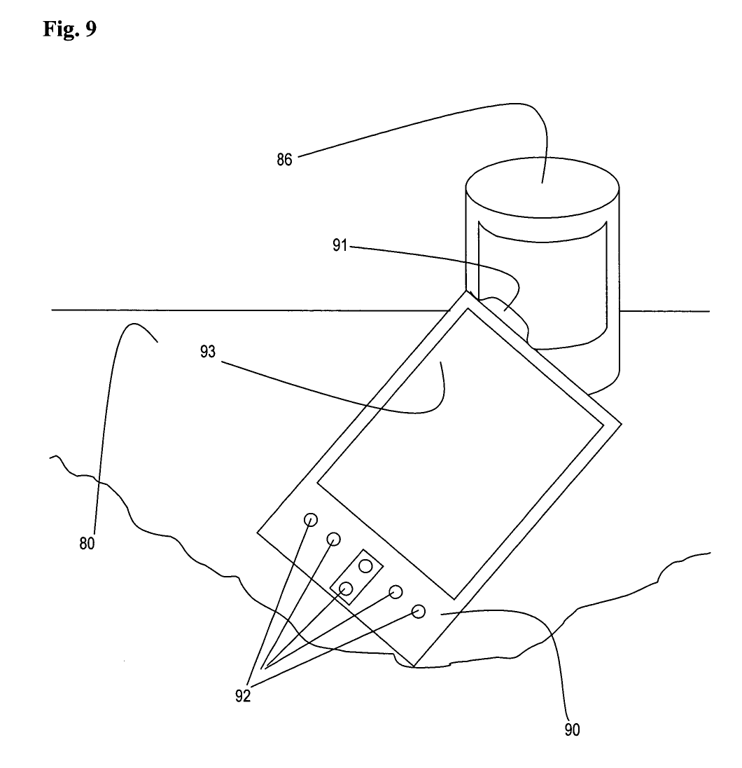

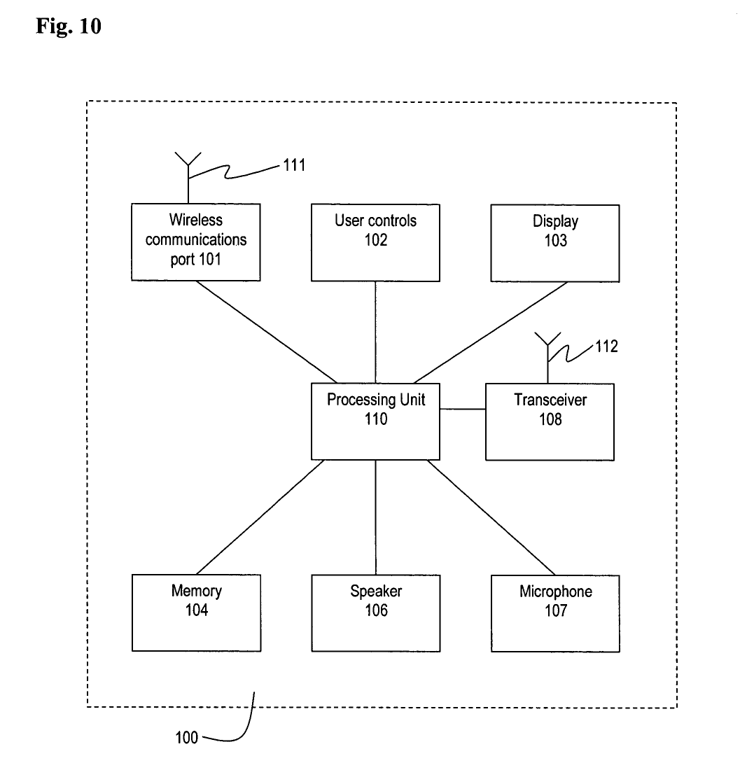

FIG. 9 depicts further aspects of a wireless device 90. In FIG. 9, an exemplary PDA 90 is shown. The PDA includes a communications port 91. The port 91 of the PDA 90 is shown as touching the port 86 of the kiosk 80. The PDA 90 includes a display 93 and user controls 92. FIG. 10 depicts further aspects of a wireless device 90 suited for practice of the invention herein.

In FIG. 10, components of an exemplary wireless device 100 are shown. The device 100 preferably includes a processing unit 110, a wireless communications port 101, user controls, 102, a display 103, a memory 104, a speaker 106, a microphone 107, and a transceiver 108. Other components may be included, or some of the above components may be omitted. As discussed herein, the wireless communications port 101 may be configured for any one (or more) of a variety of communications protocols. In preferred embodiments, the port 101 is configured for receiving a spread spectrum, frequency hopping, full-duplex signal. The port 101 may include an appropriate antenna 111, which may be internal or external to the device 100. The transceiver 108 includes typical components found in a transceiver for a mobile telephone 22, and may include a separate antenna 112 for communication with a mobile telephone network. Antenna 112 may be configured in any manner suitable for operation of the communications channel of the device 100. In some embodiments, one wireless communications channel completes the task of both the transceiver 108 and the port 101.

In some embodiments of the use of the wireless device 100, the user manipulates a user control 102 to make the device 100 known to the network 11, or to “register” the device 100. That is, once the network 11 receives a broadcast from the wireless device 100, and the identity of the wireless device 100 is known to the network 11, then the combination of the wireless device 100 and the network 11 communicate context sensitive information as disclosed herein. In other embodiments, the device 100 and the network automatically discover each other, such as through the mechanisms of the Service Discovery Protocol implemented in the Bluetooth® standard.

It is anticipated that many apparatus may implement the teachings herein. For example, many vehicles may include the teachings herein, including automobiles, airplanes, boats, motorcycles, etc, . . . Many home appliances including electronic devices such as a stereo, a camera, a television; a musical instrument; refrigerators, a stove, a microwave, a garbage disposal, a washing machine, a furnace, a boiler, a clothes dryer, power tools, a vacuum cleaner, and others. Other appliances may implement the teachings herein. For example, industrial or commercial equipment such as: electronic laboratory equipment (e.g., a computer, an oscilloscope); construction equipment (e.g., a crane); restaurant equipment (e.g, a walk-in cooler); financial equipment (e.g, a cash register); office building equipment (e.g., an elevator); and many others. The list of apparatus that may employ the teachings herein is virtually limitless. Accordingly, all of the examples given are considered to be illustrative and non-limiting of the invention herein.

One skilled in the art will recognize that the invention disclosed herein is not limited to the disclosed embodiments. For example, other settings may make use of the teachings herein. As one example, the teachings herein may be advantageously practiced in a great many aspects of a theme park operation. Furthermore, additional techniques may be used for communication of the context sensitive material. It is considered that these other embodiments are within the teachings herein, and thus will be anticipated by this disclosure.

What is claimed is:

1. A method for providing a wireless device with context sensitive information related to a theme, the method comprising:
synchronizing a network with the theme, the network comprising a source of context sensitive information and at least one port for receiving a request for context sensitive information from the wireless device and for distributing context sensitive information;
requesting the context sensitive information by contacting the at least one port of the network with a communications port of the wireless device; and,
providing to the wireless device through the at least one port a signal comprising the requested context sensitive information.

2. The method of claim 1, wherein synchronizing comprises starting a showing of a pre-recorded media.

3. The method of claim 1, wherein the source of context sensitive information comprises a database.

4. The method as in claim 3, wherein the database is reachable through the Internet.

5. The method as in claim 1, further comprising notifying a user of the wireless device of the availability of the context sensitive information.

6. The method as in claim 5, wherein the notifying comprises producing a visible icon.

7. The method as in claim 1, wherein the context sensitive information comprises at least one of a movie clip, a music title, promotional information, contest information and advertising.

8. The method as in claim 1, wherein a user of the wireless device receives the context sensitive information using one of: a mobile telephone, a personal digital assistant (PDA), a pager, and a computer comprising a wireless communications interface.

9. An apparatus for providing a wireless device with context sensitive information related to a theme, the apparatus comprising:
a device for synchronizing a network with the theme, the network comprising a source of context sensitive information and at least one port for receiving a request for context sensitive information from the wireless device and for distributing context sensitive information; wherein the at least one port is adapted for providing to the wireless device a signal comprising the context sensitive information.

10. An apparatus as in claim 9, wherein the at least one port comprises an infrared (IR) communications port.

11. An apparatus as in claim 9, wherein the at least one port is adapted for using low power radio frequency tags.

12. An apparatus as in claim 9, wherein the at least one port implements a short messaging service protocol.

13. An apparatus as in claim 9, wherein the at least one port implements a Bluetooth protocol.

14. An apparatus as in claim 9, wherein the context sensitive material comprises information that is at least one of: instructional; diagnostic; price related; performance related; specification related; and, schedule related.

15. An apparatus as in claim 9, wherein the context sensitive material comprises at least one of a movie clip; a music title; advertising material; and, promotional material.

16. A method for providing a wireless device with context sensitive information related to an operation of an apparatus, the method comprising:
providing an apparatus comprising a network linked to at least one sensor, a source of context sensitive information, and at least one port for receiving a request for context sensitive information and for distributing the context sensitive information;
monitoring the operation of the apparatus with the at least one sensor to produce operational data;
contacting the at least one port with the wireless device to request the context sensitive information;
using the operational data to select context sensitive information; and
providing the context sensitive information to the wireless device through the at least one port.

17. A method as in claim 16, wherein a communications protocol for the at least one port is a Bluetooth protocol.

18. A method as in claim 16, wherein the monitoring comprises operating a processing unit.

19. An apparatus adapted for providing a wireless device with context sensitive information related to the operation of the apparatus, the apparatus comprising:
a processing unit for synchronizing a network with the apparatus, the network comprising a source of context sensitive information and at least one port for receiving a request for context sensitive information and for distributing context sensitive information; wherein the at least one port is adapted for providing to the wireless device a signal comprising the context sensitive information.

20. An apparatus as in claim 19, wherein the apparatus comprises an appliance.

21. An apparatus as in claim 19, wherein the apparatus comprises a vehicle.

22. An apparatus as in claim 19, wherein the source comprises a remote database reachable through the Internet.

23. A method for receiving context sensitive information with a wireless device, the method comprising:
contacting a network with the wireless device, the network comprising a source of context sensitive information and at least one port for receiving a request for context sensitive information from the wireless device and for distributing context sensitive information; wherein the network is synchronized with a theme; the network
communicating with the wireless device through the at least one port; and,
downloading the context sensitive information to the wireless device.

24. The method as in claim 23, wherein a protocol for the communicating comprises the Bluetooth protocol.

25. The method as in claim 23, wherein a protocol for the communicating comprises an infrared (IR) communications protocol.

26. The method as in claim 23, wherein a protocol for the communicating comprises a protocol adapted for using low power radiofrequency tags.

27. The method as in claim 23, wherein a protocol for the communicating comprises a short messaging service protocol.

28. A wireless device for receiving context sensitive information, the device comprising:
a wireless communications port for communicating with a network, the network comprising a source of context sensitive information and at least one port for receiving a request for the context sensitive information from the wireless device and for distributing the context sensitive information; the network being synchronized with a theme; wherein the wireless device receives the context sensitive information through the wireless communications port.

29. A wireless device as in claim 28, wherein the wireless device waits for a command to accept or reject a download of the context sensitive information before downloading the context sensitive information.

30. A wireless device as in claim 28, wherein a user of the wireless device provides a command to accept or reject a download of the context sensitive information.

31. The wireless device as in claim 28, wherein a protocol for the wireless communications port comprises the Bluetooth protocol.

32. The wireless device as in claim 28, wherein a protocol for the wireless communications port comprises an infrared (IR) communications protocol.

33. The wireless device as in claim 28, wherein a protocol for the wireless communications port comprises a protocol adapted for using low power radio frequency tags.

34. The wireless device as in claim 28, wherein a protocol for the wireless communications port comprises a short messaging service protocol.

35. A method for providing a wireless device with context sensitive information related to a showing of a movie, the method comprising:
synchronizing a network with the showing of the movie, the network comprising a source of context sensitive information and at least one port for receiving a request for context sensitive information from the wireless device and for distributing context sensitive information;
requesting the context sensitive information by contacting the at least one port of the network with a communications port of the wireless device; and,
providing to the wireless device through the at least one port a signal comprising the requested context sensitive information.

36. The method as in claim 35, further comprising notifying a user of the wireless device of the availability of the context sensitive information.

37. The method as in claim 35, wherein the notifying comprises producing a visible icon.

38. A method as in claim 35, wherein the context sensitive information comprises at least one of a movie clip; a music title; advertising material; and, promotional material.
